(19) United States
(12) Patent Application Publication
(10) Pub. No.: US 2013/0033682 A1
(43) Pub. Date: Feb. 7, 2013

(54) LIGHT SOURCE DEVICE AND PROJECTOR HAVING SAME

(71) Applicants: CHIEN-WEN HSU, Tu-Cheng (TW); WEN-PIN YEH, Tu-Cheng (TW)

(72) Inventors: CHIEN-WEN HSU, Tu-Cheng (TW); WEN-PIN YEH, Tu-Cheng (TW)

(73) Assignee: HON HAI PRECISION INDUSTRY CO., LTD., Tu-Cheng (TW)

(21) Appl. No.: 13/472,505

(22) Filed: May 16, 2012

(30) Foreign Application Priority Data
Aug. 3, 2011 (TW) 100127654

(51) Int. Cl. G03B 21/28; G03B 21/14; F21V 9/00

(52) U.S. Cl. 353/33; 362/231

(57) ABSTRACT

A projector includes a projection lens set, a digital micro-mirror device, a prism unit, a light guide unit, and a light source device. The light source device includes a light emitting diode (LED), a laser light source, and a color wheel. The LED is positioned in a first optical path and generates a first light. The laser light source is positioned in a second optical path and generates a second light. The color wheel is positioned in the second optical path. The second light irradiates the color wheel to generate a third light. The light merging unit merges the first, second, and third lights to generate a mixed light. The light guide unit guides the mixed light to the prism unit. The mixed light is refracted to the DMD via the prism unit, and then the refracted mixed light is reflected to the projection lens set via the DMD.

### BACKGROUND

1. Technical Field

The present disclosure relates to a light source device and a projector having the light source device.

2. Description of Related Art

As projectors become more commonly used, heightened requirements are imposed on the imaging quality of the projectors. Generally, a projection system primarily includes a light source device and a projection lens set. Special emphasis has been put on improving the arrangement reliability of components, shrinking the overall volume and increasing the light source efficiency in the light source device to enhance the imaging brightness in the back-end projection lens set.

To improve the image brightness, a conventional projector utilizes a number of light sources to provide various color lights. However, the light sources of the light source device not only lead to a complex and bulky design of the internal structure of the projector, but also causes poor heat dissipation. After a period of operation, the heat accumulated by the high temperature tends to shorten the lifetime of the projector and cause damage to the light source device.

Thus, there is a need for a projector which can overcome the above described shortcomings.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a schematic view of one embodiment of a projector.

FIG. 2 is a schematic view of one embodiment of a color wheel of the projector shown in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

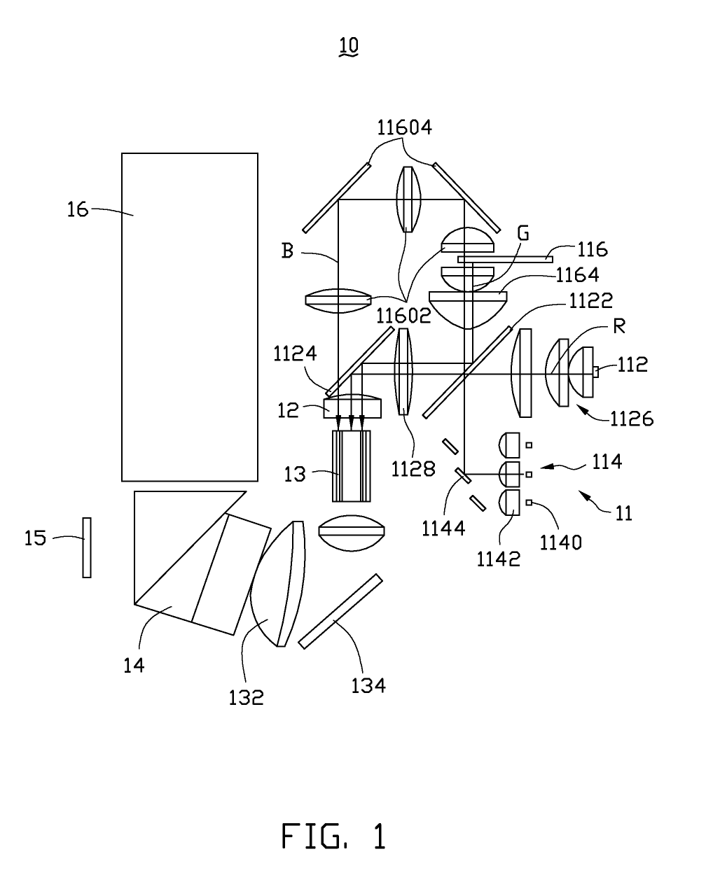

According to one embodiment, a projector 10 as illustrated in FIG. 1 includes a light source device 11, a light merging unit 12, a light guide unit 13, a prism unit 14, a digital micro-mirror device (DMD) 15, and a projection lens set 16. The projector 10 and the light source device 11 comprise a number of mirrors 134, 1144, 11604 and a number of lenses 132, 1128, 1142, 1164, 11602. The light source device 11 and the projection lens set 16 are positioned at two opposite sides of the projector 10, respectively. In one embodiment, the light guide unit 13 is a light tunnel The prism unit 14 is a reverse total internal reflection (TIR) prism including two prisms combined together.

The light source device 11 includes an LED 112, a laser light source 114, a color wheel 116, a first dichroic mirror 1122, a second dichroic mirror 1124, and a lens set 1126. The LED 112, the lens set 1126, the first dichroic mirror 1122, the second dichroic mirror 1124, and the lens 1128 are positioned in the light source device 11 along a first optical path. The laser light source 114, the lenses 1142, the mirrors 1144, and the color wheel 116 are positioned in the light source device 11 along a second optical path. The lens set 1126 is positioned between the LED 112 and the first dichroic mirror 1122. The lens 1128 is positioned between the first dichroic mirror 1122 and the second dichroic mirror 1124. In one embodiment, the first optical path is substantially perpendicular to the second optical path.

When the projector 10 operates, the LED 112 generates a first light along the first optical path, and the laser light source 114 generates a second light along the second optical path. In one embodiment, the LED 112 is a red LED for generating a red light R. The laser light source 114 includes a number of laser generators 1140 for generating a blue light B. In one embodiment, the laser light source 114 includes six laser generators 1140. The LED 112 and the laser generators 1140 are positioned at the same side of the light source device 11.

The red light R irradiates the second dichroic mirror 1124 through the lens set 1126, the first dichroic mirror 1122, and the lens 1128. The lens set 1126 and the lens 1128 focus the red light R generated from the LED 112. The second dichroic mirror 1124 reflects the red light R to the light merging unit 12. The lens 1142 focus the blue light B generated from the laser light source 114. The mirror 1144 reflects the blue light B. The reflected blue light B irradiates a surface of the color wheel 116. In other words, the blue light B irradiates the surface of the color wheel 116 through the lens 1142 and the first dichroic mirror 1122.

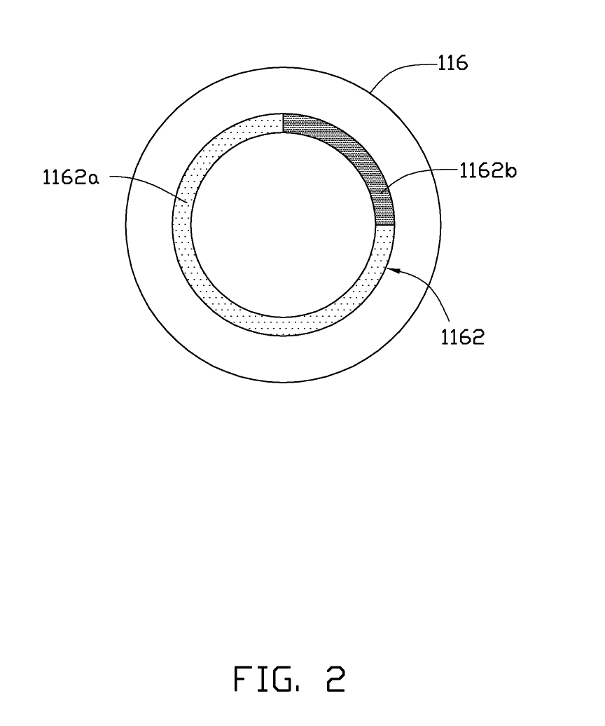

Referring to FIG. 2, the surface of the color wheel 116 including an annular irradiative area 1162 having a first irradiative area 1162a and a second irradiative area 1162b. A phosphor layer is applied on the first irradiative area 1162a. The second irradiative area 1162b is a transparent area without phosphor layer. When the blue light B irradiates the first irradiative area 1162a with the phosphor layer of the color wheel 116, the phosphor layer of the first irradiative area 1162a generates a third light due to the irradiation of the blue light B. In one embodiment, the third light is a green light G. The green light G irradiates the first dichroic mirror 1122 through the lens 1164. The first dichroic mirror 1122 reflects the green light G to the second dichroic mirror 1124 through the lens 1128. In other words, the green light G irradiates the second dichroic mirror 1124 via the lenses 1128, 1164 and the first dichroic mirror 1122. The second dichroic mirror 1124 reflects the green light G to the light merging unit 12. The lens 1164 focus the green light G generated from the phosphor layer of the first irradiative area 1162a.

When the blue light B irradiates the second irradiative area 1162b of the color wheel 116, the blue light B passes through the second irradiative area 1162b of the color wheel 116 and irradiates the second dichroic mirror 1124 via two mirrors 11604 and three lenses 11602 due to the transparency of the second irradiative area 1162b. Afterward, the blue light B passes through the second dichroic mirror 1124 to the light merging unit 12.

The light merging unit 12 merges the red light R generated from the LED 112, the blue light B generated from the laser light source 114, and the green light G generated from the phosphor layer of the first irradiative area 1162a to generate a mixed light. The light guide unit 13 guides the mixed light to the prism unit 14 by the reflection of the mirror 134 and the focusing of the lens 132. The mixed light is refracted to the DMD 15 via the prism unit 14. The refracted mixed light is reflected to the projection lens set 16 via the DMD 15. Thus, the projector 10 can project an image on a screen.

Accordingly, with the structure and features of the light source device of this invention, the light source device may have a number of light sources positioned in a simple way. This may avoid, not only the increase in volume of the projector due to the complex mechanical structures, but also the degradation in heat dissipation performance arising from the light source device. Additionally, the light source device of this invention may shorten the optical paths of lights generated from the light sources of the light source device to enhance the optical efficiency and save costs.

It is to be understood that the above-described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The above-described embodiments illustrate the scope of the disclosure but do not restrict the scope of the disclosure.

What is claimed is:

1. A light source device for a projector, comprising:
a light emitting diode (LED), positioned in a first optical path, the LED being configured for generating a first light along the first optical path;
a laser light source, positioned in a second optical path, the laser light source being configured for generating a second light along the second optical path;
and a color wheel positioned in the second optical path;
wherein the second light irradiates the color wheel, and the color wheel generates a third light due to the irradiation of the second light.

2. The light source device as claimed in claim 1, further comprising:
a first dichroic mirror positioned at the intersection of the first optical path and the second optical path; and
a second dichroic mirror positioned in the first optical path.

3. The light source device as claimed in claim 2, further comprising a lens set positioned between the LED and the first dichroic mirror.

4. The light source device as claimed in claim 3, further comprising a lens positioned between the first and second dichroic mirrors; the first light irradiates the second dichroic mirror through the lens set, the first dichroic mirror, and the lens; the first dichroic mirror reflects the third light, and the reflected third light irradiates the second dichroic mirror through the lens.

5. The light source device as claimed in claim 2, further comprising a mirror being configured for reflecting the second light, wherein the reflected second light irradiates the color wheel through the first dichroic mirror.

6. The light source device as claimed in claim 1, wherein the color wheel comprises at least one irradiative area with a phosphor layer, the second light irradiates the at least one irradiative area to generate the third light.

7. The light source device as claimed in claim 1, wherein the color wheel has a surface comprising an annular irradiative area, the annular irradiative area comprises a first irradiative area with a phosphor layer and a second irradiative area, the second irradiative area is a transparent area without phosphor layer, the second light irradiates the phosphor layer of the first irradiative area to generate the third light and transmits through the second irradiative area.

8. The light source device as claimed in claim 1, wherein the first light is a red light, the second light is a blue light, and the third light is a green light.

9. A projector, comprising:
a light source device comprising:
an LED, positioned in a first optical path, the LED being configured for generating a first light along the first optical path;
a laser light source, positioned in a second optical path, the laser light source being configured for generating a second light along the second optical path; and
a color wheel positioned in the second optical path, wherein the second light irradiates the color wheel, and the color wheel generates a third light due to the irradiation of the second light;
a light merging unit configured for merging the first, second, and third lights to generate a mixed light;
a projection lens set;
a digital micro-mirror device (DMD);
a prism unit; and
a light guide unit configured for guiding the mixed light to the prism unit;
wherein the mixed light is refracted to the DMD via the prism unit, and then the refracted mixed light is reflected to the projection lens set via the DMD.

10. The projector as claimed in claim 9, wherein the light source device further comprises:
a first dichroic mirror positioned at the intersection of the first optical path and the second optical path; and
a second dichroic mirror positioned in the second optical path.

11. The projector as claimed in claim 10, wherein the light source device further comprises a lens set positioned between the LED and the first dichroic mirror.

12. The projector as claimed in claim 11, wherein the light source device further comprises a lens positioned between the first and second dichroic mirrors; the first light irradiates the second dichroic mirror through the lens set, the first dichroic mirror, and the lens; the first dichroic mirror reflects the third light, and the reflected third light irradiates the second dichroic mirror through the lens.

13. The projector as claimed in claim 10, wherein the light source device further comprises a mirror configured for reflecting the second light, and the reflected second light irradiates the color wheel through the first dichroic mirror.

14. The projector as claimed in claim 9, wherein the color wheel of the light source device comprises at least one irradiative area with a phosphor layer, the second light irradiates the at least one irradiative area to generate the third light.

15. The projector as claimed in claim 9, wherein the color wheel has a surface comprising an annular irradiative area, the annular irradiative area comprises a first irradiative area with a phosphor layer and a second irradiative area, the second irradiative area is a transparent area without phosphor layer; the second light irradiates the phosphor layer of the first irradiative area to generate the third light and transmits through the second irradiative area to the light merging unit.

16. The projector as claimed in claim 9, wherein the prism unit is a reverse total internal reflection (TIR) prism.

17. The projector as claimed in claim 16, wherein the reverse TIR prism comprises two prisms combined together.

18. The projector as claimed in claim 9, wherein the first light is a red light, the second light is a blue light, and the third light is a green light.
